(19) United States
(12) Patent Application Publication
(10) Pub. No.: US 2014/0323152 A1
(43) Pub. Date: Oct. 30, 2014

(54) METHOD AND APPARATUS FOR RELATIVE TIMING MEASUREMENTS

(71) Applicants: Yang Zhang, Shanghai (CN); Youping Su, Solna (SE); Chunhui Zhang, Taby (SE)

(72) Inventors: Yang Zhang, Shanghai (CN); Youping Su, Solna (SE); Chunhui Zhang, Taby (SE)

(73) Assignee: Telefonaktiebolaget L M Ericsson (publ), Stockholm (SE)

(21) Appl. No.: 14/359,409

(22) PCT Filed: Nov. 21, 2011
(86) PCT No.: PCT/CN2011/082518

§ 371 Date: May 20, 2014

(51) Int. Cl. G01S 5/02; H04W 64/00

(52) U.S. Cl. CPC G01S 5/0289; G01S 5/0263; H04W 64/00
USPC 455/456.1

(57) ABSTRACT

The present invention relates to radio base station and to a related method for supporting positioning. The method includes measuring a relative time of arrival of two reference signals, where a first of the two reference signals is transmitted from a first neighboring radio base station. The method also includes transmitting the measured relative time of arrival to a positioning node, connected to the radio base station and the first neighboring radio base station.

### TECHNICAL FIELD

The embodiments described herein relate to radio base station timing relation measurements and in particular to a radio base station and a method for supporting positioning through measurements of relative timing measurements.

### BACKGROUND

The Universal Mobile Telecommunication System (UMTS) is one of the third generation mobile communication technologies designed to succeed GSM. 3GPP Long Term Evolution (LTE) is a project within the 3^{rd} Generation Partnership Project (3GPP) to improve the UMTS standard to cope with future requirements in terms of improved services such as higher data rates, improved efficiency, and lowered costs. The Universal Terrestrial Radio Access Network (UTRAN) is the radio access network of a UMTS and Evolved UTRAN (E-UTRAN) is the radio access network of an LTE system. In an E-UTRAN, a user equipment (UE) 150 is wirelessly connected to a radio base station (RBS) 110a commonly referred to as an evolved NodeB (eNodeB), as illustrated in FIG. 1. Each eNodeB 110a-c serves one or more areas referred to as cells 120a-c. In FIG. 1, a link between two nodes such as the link between a positioning node, here called Evolved Serving Mobile Location Center (eSMLC) 100, and an eNodeB 110a-c, may be either a logical link e.g. via higher-layer protocols or via other nodes, or it may be a direct link. Hereinafter, a UE in a positioning architecture is a general term covering a positioning target which may e.g. be a mobile device, a laptop, a small radio node or base station, a relay, or a sensor. A radio base station is a general term for a radio network node capable of transmitting radio signals. A radio base station may e.g. be a macro base station, a micro base station, a home eNodeB, a beaconing device, or a relay.

UE positioning is a process of determining UE coordinates in space. Once the coordinates are available, they may be mapped to a certain place or location. The mapping function and delivery of the location information on request are parts of a location service which is required for basic emergency services. Services that further exploit location knowledge or that are based on location knowledge to offer customers some added value are referred to as location-aware and location-based services. The possibility of identifying a UE's geographical location has enabled a large variety of commercial and non-commercial services such as navigation assistance, social networking, location-aware advertising, and emergency calls. Different services may have different positioning accuracy requirements imposed by an application. Furthermore, requirements on the positioning accuracy for basic emergency services defined by regulatory bodies exist in some countries. An example of such a regulatory body is the Federal Communications Commission (FCC) regulating the area of telecommunications in the United States.

There exist a variety of positioning techniques in wireless communications networks, differing in their accuracy, implementation cost, complexity, and applicability in different environments. Positioning methods may be broadly categorized into satellite based and terrestrial methods. Global Navigation Satellite System (GNSS) is a standard generic term for satellite navigation systems that enable UEs to locate their position and acquire other relevant navigational information. The Global Positioning System (GPS) and the European Galileo positioning system are well known examples of GNSS. In many environments, the position may be accurately estimated by using positioning methods based on GPS. Nowadays wireless networks also often have a possibility to assist UEs in order to improve UE receiver sensitivity and GPS start up performance, as for example in the Assisted-GPS (A-GPS) positioning method. However, GPS or A-GPS receivers are not necessarily available in all wireless UEs, and some wireless communications systems do not support A-GPS. Furthermore, GPS-based positioning may often have unsatisfactory performance in urban and/or indoor environments. There may therefore be a need for a complementary terrestrial positioning method.

There are a number of different terrestrial positioning methods. Some examples are:
Cell Identity (CID) based positioning, where the location is based on the identity of the current cell Enhanced CID (E-CID) also takes e.g. Timing Advance (TA) into account to improve the positioning accuracy which may be important for positioning in large cells.
UE-based and UE-assisted Observed Time Difference Of Arrival (OTDOA), where the UE position is determined based on UE measurements of reference signals from three or more sites or locations.
Network based Uplink Time Difference Of Arrival (UTDOA) positioning, where the UE position is determined based on several uplink measurements of a reference signal transmitted by the UE. Multi-lateration is then used to find a UE position as the intersection of hyperbolas when based on time difference measurements, or of circles when based on time of arrival measurements.
Fingerprinting or pattern matching positioning, where location fingerprints are collected in an off-line phase and are used for mapping measured signal strengths with a position.

Positioning methods based on time difference of arrival (TDOA) measurements have been widely used, for example in GSM, UMTS and cdma2000. For LTE networks, UE-assisted OTDOA positioning which is based on downlink TDOA measurements has been standardized. A corresponding UE-based mode is another possible candidate for later releases. The UE-assisted and UE-based modes differ in where the actual position calculation is carried out.

In the UE-assisted mode, the UE measures the TDOA of several cells and sends the measurement results to the network. A positioning node or a location server in the network carries out a position calculation based on the measurement results. In LTE, the positioning node in the control plane is referred to as an eSMLC. The eSMLC 100 is either a separate network node, as illustrated in FIG. 1, or a functionality integrated in some other network node. In the UE-based mode, the UE makes the measurements and also carries out the position calculation. The UE thus requires additional information for the position calculation, such as a position of the measured RBSs and a timing relation between the RBSs.

The OTDOA positioning has won good acceptance among operators and vendors for LTE positioning. Some operators have already started to plan for an OTDOA deployment in the LTE system. Moreover, the OTDOA related protocol in E-UTRAN has been adopted by the Open Mobile Alliance for user plane positioning. OTDOA is already standardized by 3GPP for GSM/EDGE RAN and UTRAN, but is not yet deployed in operational networks.

The OTDOA positioning is a multi-lateration technique measuring TDOA of reference signals received from three or more sites. The basic idea is illustrated in FIG. 2. To enable positioning, the UE should thus be able to detect positioning reference signals from at least three geographically dispersed RBS 210a-c with a suitable geometry, as the UE's 250 position may be determined by the intersection 230 of at least two hyperbolas 240. This implies that the reference signals need to be strong enough or to have high enough signal-to-interference ratio in order for the UE to be able to detect them. With the OTDOA technique, the UE's position may be figured out based on the following measured parameters:
TDOA measurements of downlink reference signals;
Actual Relative Time Difference (RTD) between the RBS transmissions at the time when TDOA measurements are made;
Geographical position of the RBS whose reference signals are measured.

With more TDOA measurements or longer TDOA measurements in time for each RBS a better accuracy may be obtained. Measuring TDOA for signals from more than three RBSs typically also improves the positioning accuracy, although additional inaccurate measurements may also degrade the final accuracy. The accuracy of each of the measurements thus contributes to the overall accuracy of the position estimate.

There are several approaches to how to determine the RTD. One is to synchronize transmissions of the RBSs, as is generally done in a system using Time Division Duplex (TDD). In this case, RTD is a known constant value that may be entered in a database and used when calculating a position estimate. The synchronization must be done to a level of accuracy of the order of tens of nanoseconds in order to get an accurate position estimate. Ten nanoseconds uncertainty corresponds to three meters of error in the position estimate. Drift and jitter in the synchronization timing must also be well-controlled as they also contribute to the uncertainty in the position estimate. Synchronization to this level of accuracy is currently available through satellite based time-transfer techniques. Another alternative is to leave the RBSs to run freely without synchronization but with some constraint on the maximum frequency error. In this scenario, the RTD will change with time. The rate of change will depend on the frequency difference between RBSs.

LTE Positioning Protocol (LPP) and LTE Positioning Protocol annex (LPPa) are protocols necessary for carrying out OTDOA in a control plane solution in LTE. When receiving a positioning request for the OTDOA method, the eSMLC requests OTDOA-related parameters from eNodeB via LPPa. The eSMLC then assembles and sends assistance data and the request for the positioning to the UE via LPP. FIGS. 3a-c illustrate LPP and LPPa protocols and their roles in the LTE network. In the control plane solution, illustrated in FIG. 3a, the UE communicates with the eSMLC transparently via the eNodeB and the Mobility Management Entity (MME) over LPP, and the eNodeB communicates with the eSMLC transparently via the MME over LPPa.

As already mentioned, it is necessary to have accurate information about timing relations of RBSs for time difference based positioning. Such information is difficult to obtain, at least with a good reliability. In LTE, the eSMLC may e.g. request absolute timing information from an eNodeB. However, it is hard to achieve a timing accuracy that is better than 100 ns, even for an eNodeB with a GNSS receiver. The timing accuracy is limited due to the one pulse per second signal from GNSS which has a limited accuracy. The timing accuracy limitation may also be due to the physical distance between the GNSS receiver and the eNodeB.

One solution to mitigate the problem of the absolute timing accuracy is to use a timing error detection scheme based on both UTDOA and OTDOA measurements to estimate a timing offset. A limitation of such a solution is that the channel between the UE and the eNodeB has a rich multipath profile which will affect the first path timing detection. Furthermore, an advanced first path detection algorithm will also be needed at the UE side which increases the complexity of the UE. Moreover, both the UTDOA and the OTDOA measurements will be subject to measurement errors which will affect the timing offset estimate. Furthermore, as two positioning measurement flows are needed, this may increase the response time of positioning service from network to UE.

### SUMMARY

An object is therefore to address some of the problems and disadvantages outlined above, and to obtain accurate timing relations between neighboring RBSs to support positioning.

The above stated object is achieved by means of a method and apparatus according to the independent claims.

In accordance with a first embodiment, a method for use in a radio base station of a communications system, for supporting positioning is provided. The method comprises measuring a relative time of arrival of two reference signals, wherein a first of the two reference signals is transmitted from a first neighboring radio base station. The method also comprises transmitting the measured relative time of arrival to a positioning node, connected to the radio base station and the first neighboring radio base station.

In accordance with a second embodiment, is radio base station of a communications system is provided. The radio base station is configured to support positioning, and comprises a processing circuitry adapted to measure a relative time of arrival of two reference signals, wherein a first of the two reference signals is transmitted from a first neighboring radio base station. The radio base station also comprises a communication circuitry adapted to transmit the measured relative time of arrival to a positioning node connectable to the radio base station and the first neighboring radio base station.

An advantage of particular embodiments is that accurate relative timing measurements between neighboring RBSs are obtained. The obtained timing relations may be used by a positioning node when providing assistance data for positioning of a wireless UE.

A further advantage is that no involvement of a user equipment is required for obtaining the relative timing measurement.

Still another advantage is that no GNSS receivers are needed in the RBSs.

Further advantages and features of embodiments of the present invention will become apparent when reading the following detailed description in conjunction with the drawings.

### BRIEF DESCRIPTION OF THE DRAWINGS

FIG. 1 is a schematic block diagram illustrating a conventional wireless communication system.

FIG. 2 schematically illustrates the basic idea behind OTDOA.

FIGS. 3a-c are schematic block diagrams illustrating positioning related entities and protocols in LTE.

FIGS. 4a-d are schematic block diagrams illustrating synchronization status for neighbor eNodeBs.

FIGS. 5a-b are signaling diagrams illustrating a proposed signaling between eNodeB and eSMLC according to embodiments.

FIG. 6a is a schematic block diagram illustrating the time domain structure for LTE Frequency Division Duplex (FDD).

FIGS. 6b-d are schematic block diagrams illustrating how LTE FDD eNodeB hardware may be adapted to support neighbor eNodeB listening, according to embodiments.

FIG. 7a is a schematic block diagram illustrating the time domain structure for LTE TDD.

FIGS. 7b-c are schematic block diagrams illustrating how LTE TDD eNodeB hardware may be adapted to support neighbor eNodeB listening, according to embodiments.

FIGS. 8a-c are flowcharts illustrating the method in an RBS according to embodiments.

FIGS. 9a-b are schematic block diagrams schematically illustrating an RBS according to embodiments.

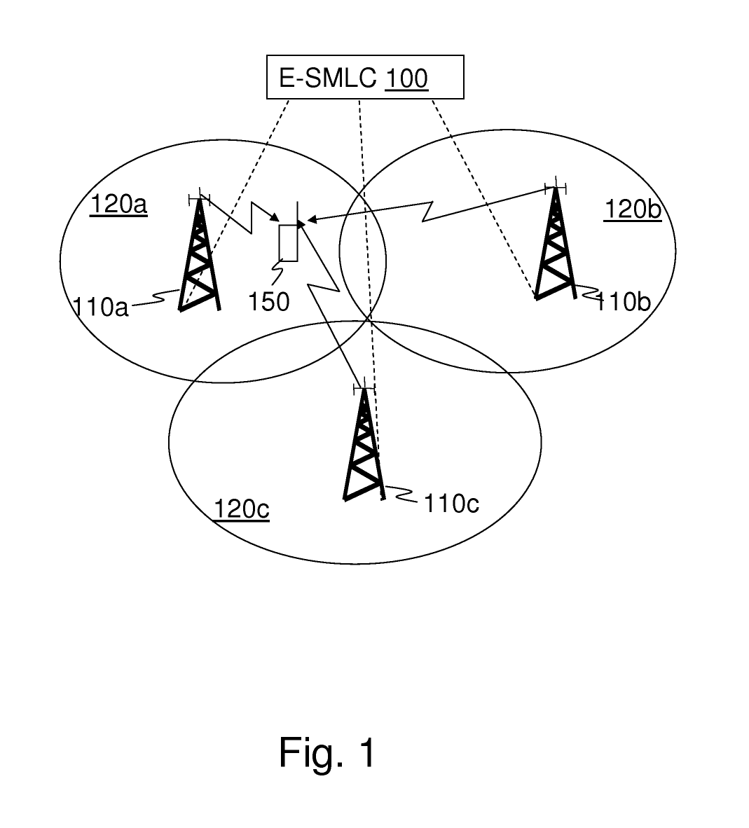

### DETAILED DESCRIPTION

In the following, different aspects will be described in more detail with references to certain embodiments and to accompanying drawings. For purposes of explanation and not limitation, specific details are set forth, such as particular scenarios and techniques, in order to provide a thorough understanding of the different embodiments. However, other embodiments that depart from these specific details may also exist.

Embodiments are described herein by way of reference to particular example scenarios. Some aspects are described in a non-limiting general context in relation to an LTE system. It should though be noted that the embodiments may also be applied to other types of radio access networks such as evolved LTE, UMTS, cdma2000, and WiFi, as well as multi radio access technology systems applying positioning based on time difference measurements.

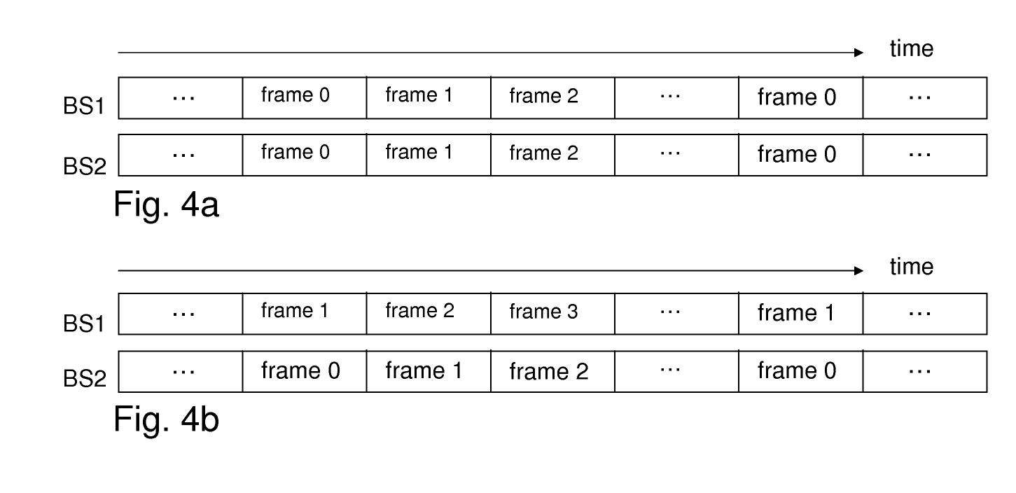

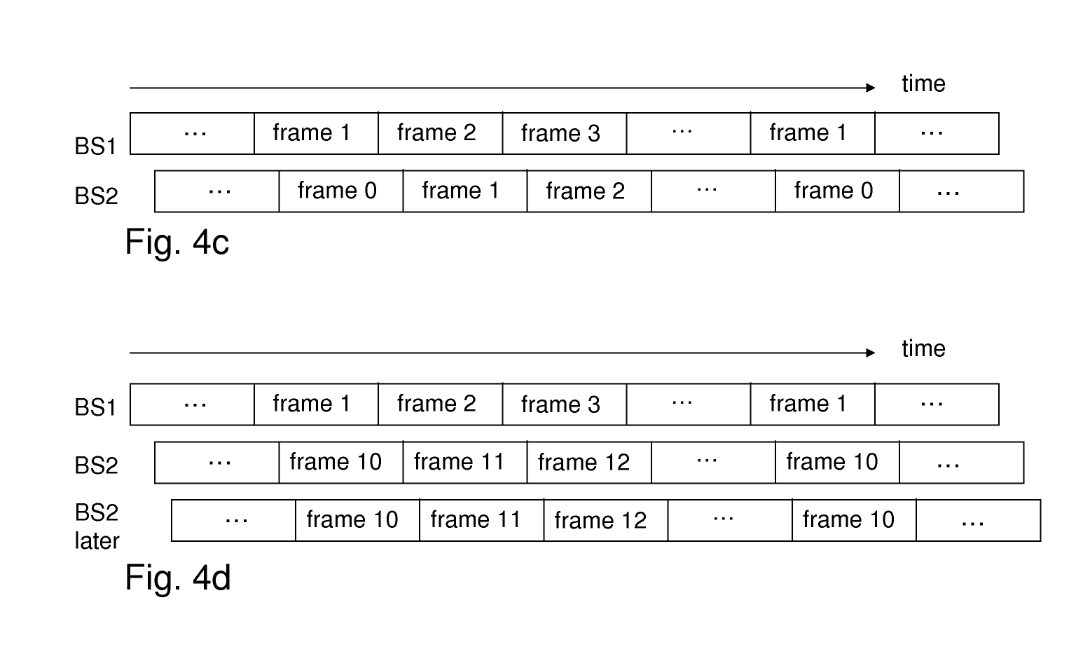

FIGS. 4a-d illustrate synchronization status of eNodeBs according to some typical synchronization situations in a wireless network. The timing relation of frame transmissions of two neighbor eNodeBs, BS1 and BS2, is illustrated. BS1 may e.g. be a reference cell and BS2 a neighbor to the reference cell. In FIG. 4a the two eNodeBs are fully synchronized. BS1 and BS2 transmit their respective frame 0 simultaneously, and are thus not only frame aligned, but also System Frame Number (SFN) aligned, which occurs among all cells in a fully synchronized network. Frame alignment means that the frame boundaries are transmitted at the same time from each eNodeB. The cells are SFN aligned if the frame boundaries of frames with a same frame number are transmitted at the same time from each eNodeB.

In FIG. 4a, the following is valid:

ΔT=T_{BS2}−T_{BS1}=e(t) [1]

where the residual error e(t) is in the order of nanoseconds if a GPS/GNSS receiver is used for the synchronization of the eNodeB clocks. The residual error e(t) typically changes over time.

It is understood that an eNodeB may have more than one cell, and the eNodeB clock may or may not be common for all cells that the eNodeB is in charge of. In the example in FIG. 4a the clock is common for all cells. In FIG. 4b, BS1 and BS2 are not SFN aligned as BS2 transmits frame 0 when BS1 transmits frame 1 and they are thus not synchronized, although they are still frame aligned. The transmissions in cells may be frame-shifted on purpose, e.g. to avoid collisions of some periodic transmissions such as system information transmitted in the same subframe of every even frame. Even though the network is called asynchronous, time synchronization of each cell to a reference time is necessary. Although the offsets are defined per eNodeB in this example, it is understood that the offsets may also be defined per cell.

In FIG. 4c, the eNodeBs are synchronized, although there is a non-zero mean timing offset that is known. BS1 and BS2 are thus not frame aligned, but there is still a non-zero offset between eNodeBs that is known. The offset may be one subframe in LTE, e.g. when cells are sub frame-shifted to avoid collisions of synchronization signals transmitted in sub frames 0 and 5 in each frame. To maintain the intended offset the cells still have to be synchronized to a certain reference time, e.g. the time drift is controlled for these cells and is typically not allowed to exceed a certain, typically quite small, level which may be in the order of a synchronization error e.g. nanoseconds. For the examples in FIGS. 4b and 4c, the following equation is applicable:

ΔT=T_{BS2}−T_{BS1}=offset+e(t) [2]

where offset corresponds to the constant timing offset between BS1 and BS2.

In FIG. 4d, the eNodeBs are not synchronized, and a time drift is present and not under control so that the offset between the eNodeBs varies with time. The following equation is applicable in this case:

ΔT=T_{BS2}−T_{BS1}=offset(t) [3]

This is illustrated in the figure by showing the frame timing of BS2 at two different points in time, which shows how the timing of BS2 drifts in time. This may e.g. be the case when both or either of the two eNodeBs or cells are using free-running clocks as a time source, e.g. without synchronizing to a reference time. If the clock stability of BS1 is 0.01 ppm and the clock stability of BS2 is −0.02 ppm, the relative timing relation is given by:

offset(t)=offset_init+0.03×10⁻⁶×t+v(t) [4]

where offset_init is the initial offset at the first observation, and v(t) is the error due to model mismatch and random interference. v(t) is generally referred to as the error variance. A more general model is given by:

$$offset ( t ) = offset\_init + DR 1 \times t + \frac{1}{2} DR 2 \times {t}^{2} + v ( t ) \qquad [ 5 ]$$

offset(t) changes over time, and DR1 and DR2 are the first and second order relative drift rates respectively. This model may of course be extended to cover higher order terms as well. Equations [1] and [2] above valid for a synchronized network, are just special cases of equation [5] which covers the non-synchronized network as well. Timing offset and drift rates, as well as error variances are hereinafter referred to as timing characteristics of the eNodeBs.

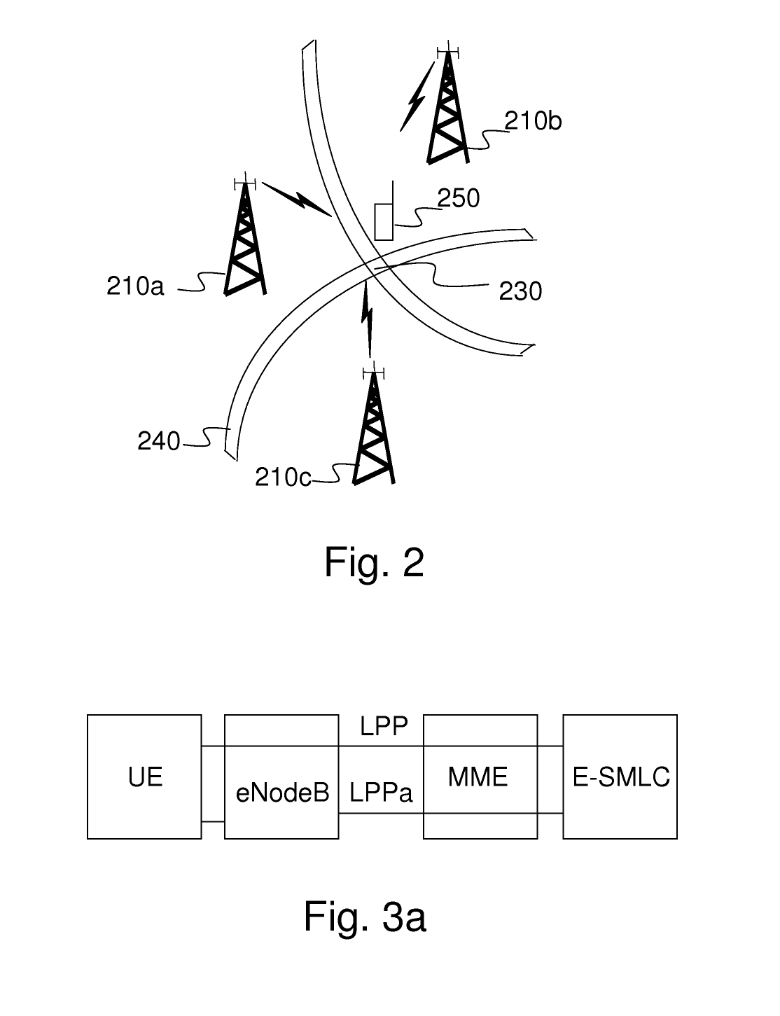

As mentioned above when describing OTDOA positioning with reference to FIG. 2, a UE receiver may have to deal with signals that are much weaker than those received from a serving cell, since signals from multiple distinct sites need to be measured for OTDOA positioning. Furthermore, without an approximate knowledge of when the measured signals are expected to arrive in time and what is the exact pattern of a positioning reference signal, the UE would need to do signal search blindly within a large search window which would impact the accuracy of the measurements, the time it takes to perform the measurements, as well as the UE complexity. Therefore, to facilitate UE positioning measurements, the wireless network transmits assistance data to the UE. The assistance data and its quality are important for both the UE-based and the UE-assisted mode, although assistance data contents may differ for the two modes. The standardized assistance data includes among others a neighbor cell list with physical cell identities, a number of consecutive downlink sub frames used for the reference signals, an expected timing difference, and a search window. The expected timing difference and the search window are crucial for an efficient reference signal correlation peak search.

As already discussed in the background section, methods and mechanisms for obtaining RBS timing relations based on absolute timing information of each RBS have been disclosed. However, for OTDOA absolute timing information is not necessary because the OTDOA accuracy is only impacted by the relative timing stability of neighbor eNodeBs.

This disclosure relates to RBS measurements of relative time of arrivals of reference signals transmitted from neighbor RBSs. Such information may be used to determine assistance data for positioning measurements. The purpose is thus to report the measured relative timings to a positioning node in order to support UE positioning. Some advantages compared to measurements based on absolute timing information are that more accurate relative timing measurement are provided, that no GNSS receiver is needed in the RBS, and that no UE involvement is required.

In embodiments, the following is proposed:

1) A method performed in the RBS for measuring and optionally also dynamically maintaining the following information:
RBS timing relation;
Uncertainty of the RBS timing relation. The uncertainty may be calculated based on historically observed RBS timing relations, known clock characteristic of each RBS, and/or the estimated propagation characteristic which may be known as the inter RBS wireless channel normally is stable.
The bsAlign indicator in LPP. Assisted GNSS (A-GNSS) is an important positioning technology, which is an extension to the existing A-GPS positioning. A-GNSS assistance data comprises among others a data field named the bsAlign indicator. When the bsAlign indicator is set to true, it indicates that the transmission timings of two RBSs or of two cells are frame aligned. The relative timing information may be used to determine the bsAlign indicator. The indicator may be valuable for the network when building up OTDOA assistance data.

2) A method for using the measured information for deriving assistance data for positioning such as the search window, and for neighbor list construction.

Hereinafter, the embodiments will be described in relation to an LTE system, where the LPPa interfaces between the eNodeBs and the eSMLC are used. The RBS is thus an eNodeB and the positioning node is the eSMLC. In embodiments, the method comprises the following steps:

Step 1: The eSMLC identifies eNodeBs for which the relative timing needs to be known. A possible criterion for the identification of an eNodeB is that the update interval of the eNodeB relative timing value is longer than an update interval. The update interval may be pre-defined or calculated. The interval calculation may be based on knowledge about the eNodeB clock drift. An eNodeB with a high drift rate may e.g. have a shorter calculated update interval than another eNodeB with a small drift rate, in order for the timing characteristics to be updated more often when the drift rate is higher.

Step 2: The eSMLC requests relative timing info from the eNodeBs identified in Step 1. The eSMLC also has the option to send some information to the eNodeB's for assistance during the measurements. The information may include neighbor eNodeB Reference Signal (RS) configuration and cell information such as antenna location, carrier frequency, and downlink power, and may e.g. be a subset of OTDOA assistance data defined in LPP. The information assisting during the measurements may in alternative embodiments be sent from an Operations and Support System (OSS) in the communications system. Based on the information, a time window for when to measure time of arrival for a RS from a neighbor eNodeB may be configured, in order to make the measurement more efficient. With information about the antenna location of the neighbor eNodeB, a distance between the two neighboring eNodeBs may be computed. Based on the distance, a travel latency and travel latency uncertainty may be calculated, and based on the travel latency information and an estimated clock error of the two eNodeBs a time window of the expected time of arrival may be deduced.

Step 3: Each eNodeB receiving the request measures a relative timing offset. The eNodeB thus measures a relative time of arrival of two RSs each transmitted by a different eNodeB. The relative time of arrival is either between two neighboring eNodeBs, or between the requested eNodeB and a neighbor eNodeB. In a first embodiment, the relative time of arrival is measured directly, and in an alternative second embodiment the time of arrival of each RS is measured and the relative time of arrival is deduced from the two time of arrival measurements. The second embodiment is possible as the eNodeB clock is stable in the short term. The measured RSs are in one embodiment Positioning RSs (PRS). PRS are transmitted in pre-defined positioning subframes, grouped in a number of consecutive subframes called a positioning occasion. Positioning occasions occur periodically, and the standardized time interval, T_{PRS} between two positioning occasions may be configured to be 160 ms, 320 ms, 640 ms, or 1280 ms. Other possible RSs to measure are cell-specific RSs, Multimedia Broadcast multicast service Single Frequency Network (MBSFN) RSs, or UE-specific RSs. The requested eNodeB may as an option receive neighbor eNodeB's rough timing information over an X2 interface between the eNodeBs. This timing information may be used by the requested eNodeB, together with other assistance information from the eSMLC or the OSS mentioned in Step 2, to refine the time window for the measurement. The measurement time is expected to be the same as the occurrence time of a PRS, defined in 3GPP TS36.211, chapter 6.10.4 to be 1-6 ms every T_{PRS}. Detailed information about the occurrence time may be deduced from neighbor eNodeB's PRS configuration and rough timing information.

It is worth noting that the eNodeB may have the option to perform unsolicited measurements, i.e. without receiving the eSMLC request in Step 1. In that case, the eNodeB is fully responsible of acquiring neighbor eNodeB information and also for determining when to measure.

When measuring relative timing, a worst case with regards to the accuracy of the measurements is when the eNodeBs have lost connection with the external reference, and have entered a holdover mode. The accuracy of the measured relative timing is thus depending on the frequency stability of the OCXO. For a CDMA system the recommendation is that the system must not exceed 10 microseconds of cumulative time error (CTE) over a period of eight hours in holdover mode. This is equivalent to an OCXO performance of 0.35 ppb. There is no holdover requirement defined for LTE eNodeBs, but a holdover requirement similar to the CDMA system may be used. The time offset between eNodeBs should ideally be within 50 ns to achieve a high accuracy positioning. This means that in a worst case holdover mode, it takes around 144 seconds to accumulate a 50 ns time offset between eNodeBs.

Step 4: After having measured the relative timing measurement, the eNodeB sends—unsolicited or upon request—the measured relative timing in a message to the eSMLC. This may be done periodically or only once. The eNodeB may then perform Step 5 and Step 6 described hereinafter.

In an alternative embodiment, the eNodeB has the option to proceed with Step 5 and Step 6 as elaborated below, after Step 3, i.e. without interacting with the eSMLC as described in Step 4. In still another embodiment, Step 5 and Step 6 may be done in parallel with the eSMLC interaction of Step 4. In this case Step 5 and Step 6 may be performed in both the eSMLC and the eNodeB.

Step 5: Relative timing characteristic for pairs of eNodeBs may be determined based on the measured relative timing. The determined relative timing characteristics may be one or more of a relative offset, a relative drift rate, and a relative timing error variance. Given a time series of relative timing values measured in Step 3, i.e. a discrete set of relative offsets offset(t) from equation [5] above, the unknown parameters offset_init, DR1, DR2 and var(v(t)), where var(v(t)) is the variance of the residual timing error, may be estimated e.g. according to the following two non-limiting approaches:
Curve fitting—with this approach the criterion of Least Square can be applied to reach a simple solution.
Kalman filtering—this approach provides a good estimate based on a minimum variance criterion.

In order to determine the bsAlign indicator, the determined relative offset may be compared with a threshold, the threshold being an upper limit for when the eNodeBs are determined to be aligned. The bsAlign indicator which is a Boolean is set to true if the relative offset is below the threshold, and to false otherwise.

Step 6: A database may be updated with the relative timing information, including:
1. The relative timing characteristics (relative offset, relative drift rate and relative timing variance) of each eNodeB pairs. The relative timing characteristics may be used to deduce an OTDOA search window;
2. The bsAlign indicator for each eNodeB.

It is worth to note that a relative stability of eNodeBs or eNodeB pairs may be obtained from data in such a database. Stability information can be utilized to deduce a reasonable update period for each eNodeB pair, for identifying eNodeBs for which the timing characteristics need to be updated, as already mentioned in Step 1 above.

The previous paragraphs have emphasized on the measurement of relative timing characteristics for supporting positioning, by allowing a build up of assistance data for positioning. The indicator bsAlign may e.g. be comprised in assistance data to the UE to improve not only A-GNSS but also OTDOA measurement quality. The indicator may also be used to create the neighbor cell lists used in assistance data. This will in turn improve a UE measurement quality or shorten a UE measurement time during OTDOA or A-GNSS positioning.

Other advantages of embodiments are:
That accurate relative timing measurement of neighbor eNodeBs are provided, as wireless channel characteristics between eNodeBs are favorable due to a good boresight view.
That the period between updates of the eNodeB relative timings may be as long as 144 seconds, even when the eNodeBs has lost their time reference and are in handover mode.
That the proposed solution does not require involvement of a UE.
That accurate relative timing information is provided for use in OTDOA positioning without using a GNSS receiver. The relative timing relation can actually be more accurate than absolute timing information such as GNSS timing information because it is less subject to GNSS system errors which may be up to +/−100 ns.
That when using relative timing information, there is no need to calibrate the radio delay bias which is due to eNodeB hardware.

Signaling Proposal

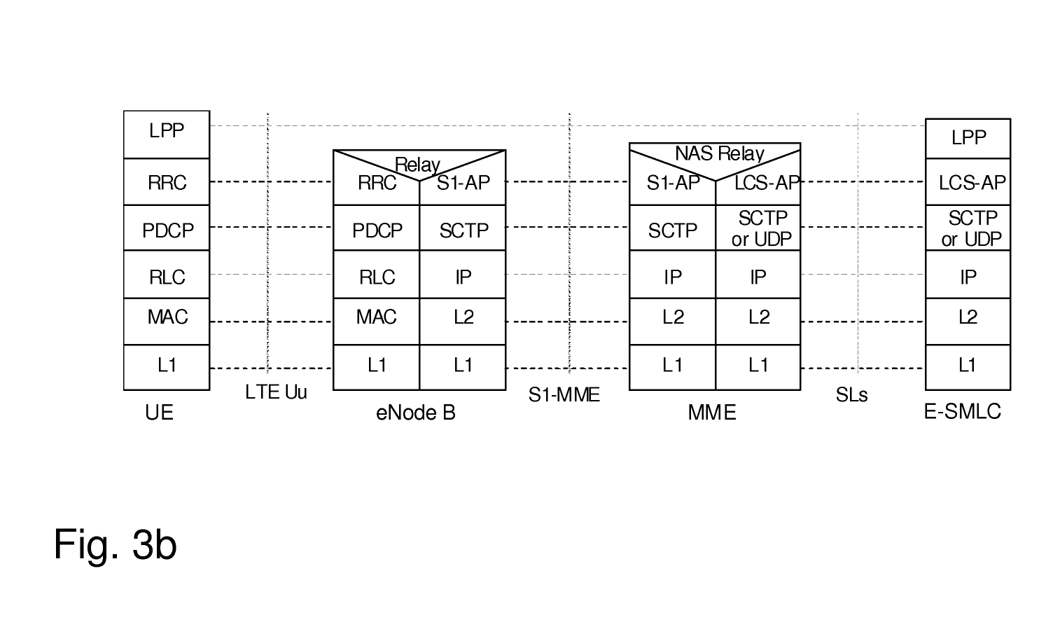

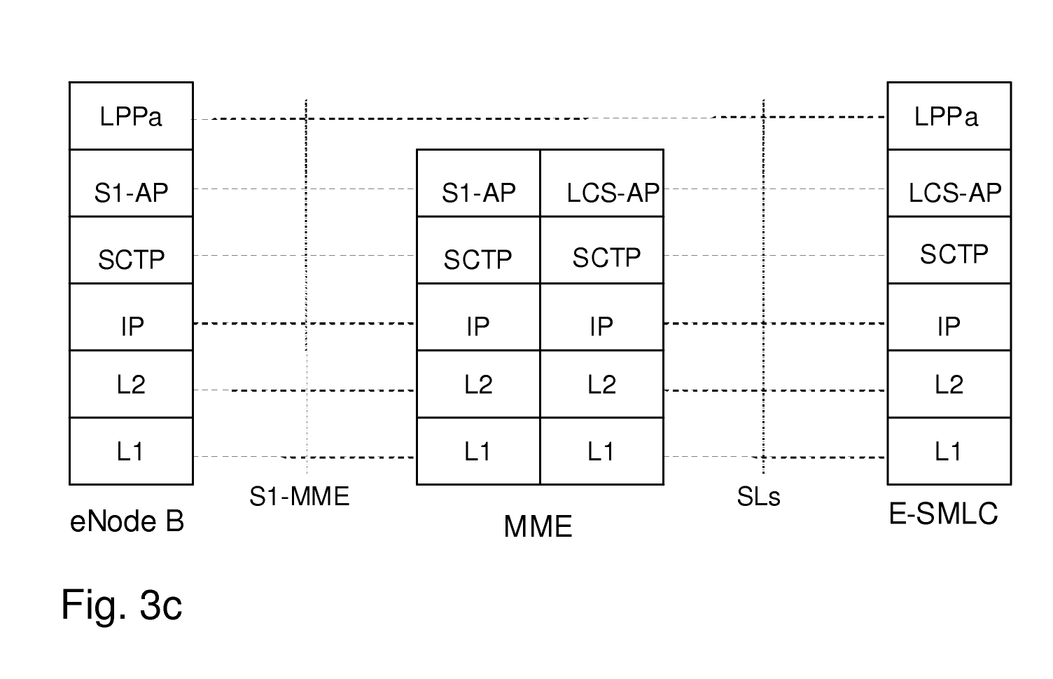

The relative timing information obtained from the measurements, and optionally the requests for the relative timing information and the results of processing of the relative timing information may be transmitted over the interfaces between the corresponding nodes. In 3GPP, the interface between eNodeB and eSMLC is standardized, and the protocol used is LPPa, as already described above with reference to FIG. 3a. As a non-limiting example of how to realize the signaling between the eNodeB and the eSMLC according to particular embodiments, extensions to LPPa may be used. However, the concrete LPPa message proposals described hereinafter are of course not necessary for the implementation, since proprietary solutions may be applied instead.

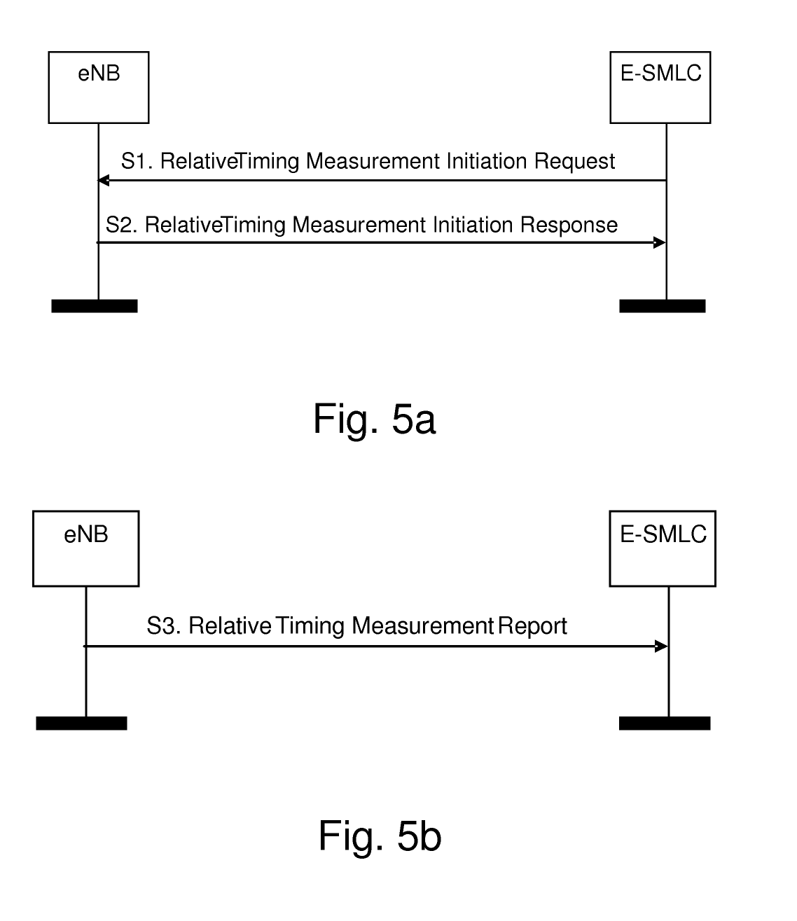

A signaling diagram of one embodiment of the initiation of the relative timing measurement procedure described in Step 2 above is illustrated in FIG. 5a. The eSMLC initiates the procedure by sending a RELATIVE TIMING MEASUREMENT INITIATION REQUEST message in S1 to the eNodeB. In this message, the eSMLC has the option to include:
1. Identities of neighbor eNodeBs;
2. A measurement type, e.g. measurement of relative timings between requested eNodeB and neighbor eNodeBs, or measurement of relative timings between two neighbor eNodeBs.

If the eNodeB is able to initiate the requested measurement, it may reply with the RELATIVE TIMING MEASUREMENT INITIATION RESPONSE message in S2.

If a report characteristics Information Element (IE) is set to On Demand, the eNodeB may return the result of the measurement in the RELATIVE TIMING MEASUREMENT INITIATION RESPONSE message in S2, and may consider that the relative timing measurement has been terminated. If the report characteristics IE is set to Periodic and a certain periodicity is indicated, the eNodeB may initiate the requested measurement and may reply with the RELATIVE TIMING MEASUREMENT INITIATION RESPONSE message in S2 without including any measurement result. The eNodeB may then periodically initiate the Relative Timing Measurement Report procedure described below for this measurement, with the indicated reporting periodicity.

A signaling diagram of one embodiment of the reporting of the relative timing measurement to the eSMLC, described in Step 4 above, is illustrated in FIG. 5b. The eNodeB initiates the procedure by sending a RELATIVE TIMING MEASUREMENT REPORT message in S3. The RELATIVE TIMING MEASUREMENT REPORT message comprises the relative timing measurement results according to the measurement configuration in the respective RELATIVE MEASUREMENT INITIATION REQUEST message in S1. The RELATIVE TIMING MEASUREMENT REPORT message may also include the uncertainty of the measurement.

The Relative Timing Measurement Solution in eNodeB

In the following, the implementation of the measurements of the time of arrival of neighbor eNodeBs RSs is described more in detail. In known solutions, the UE is measuring the time of arrival of RSs from the eNodeBs for the purpose of determining a relative timing. However, in the current solution, an eNodeB is measuring a timing difference by listening to neighbor eNodeBs RSs.

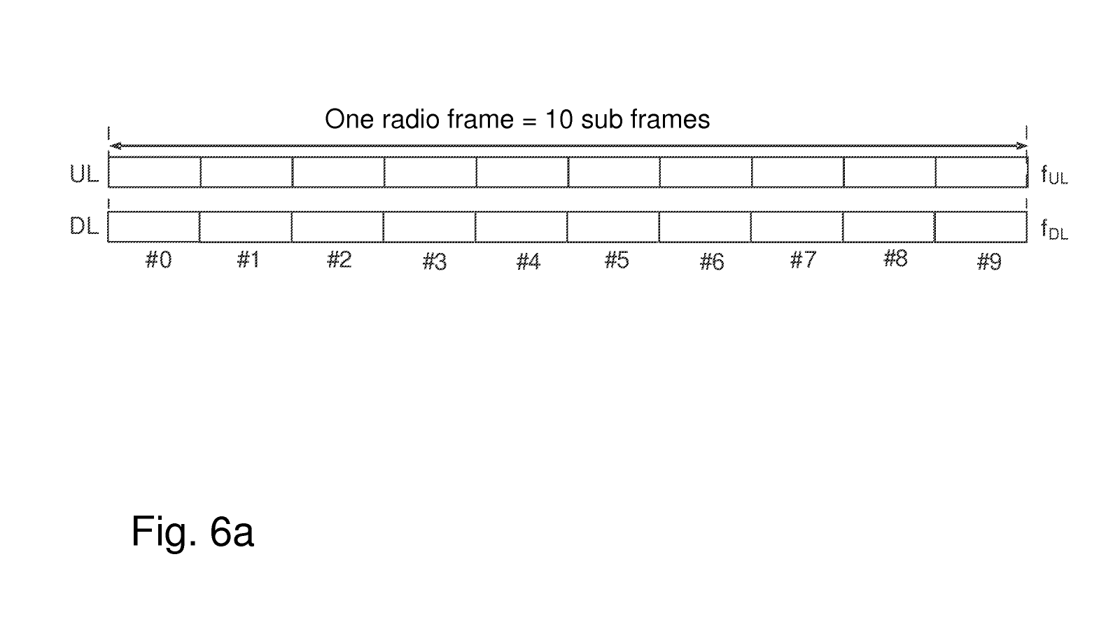

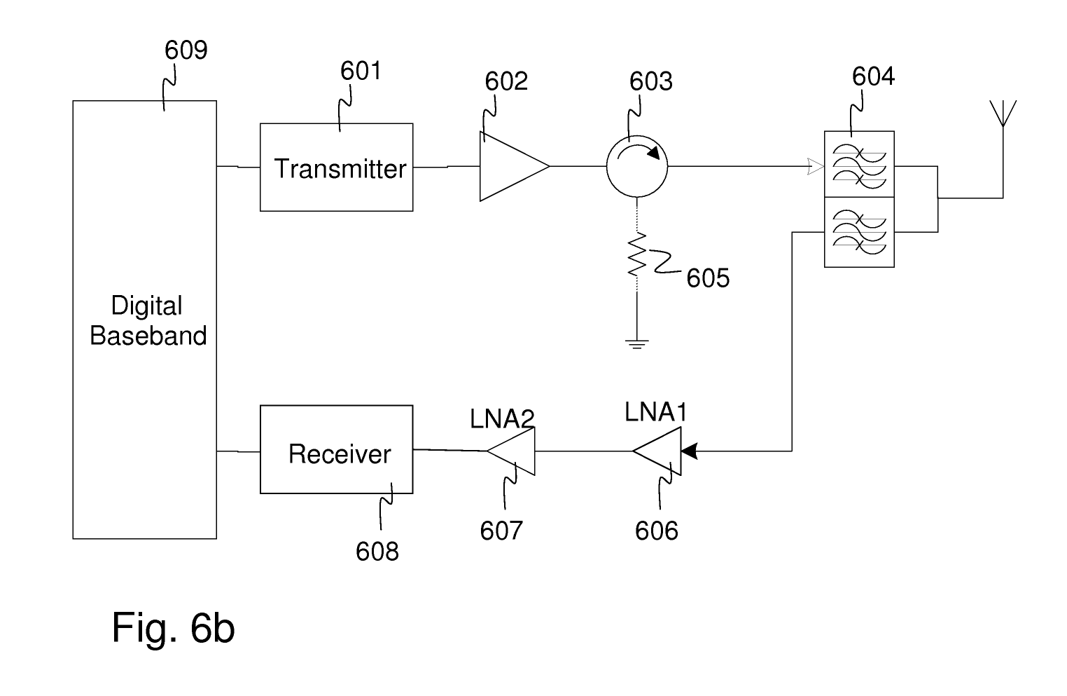

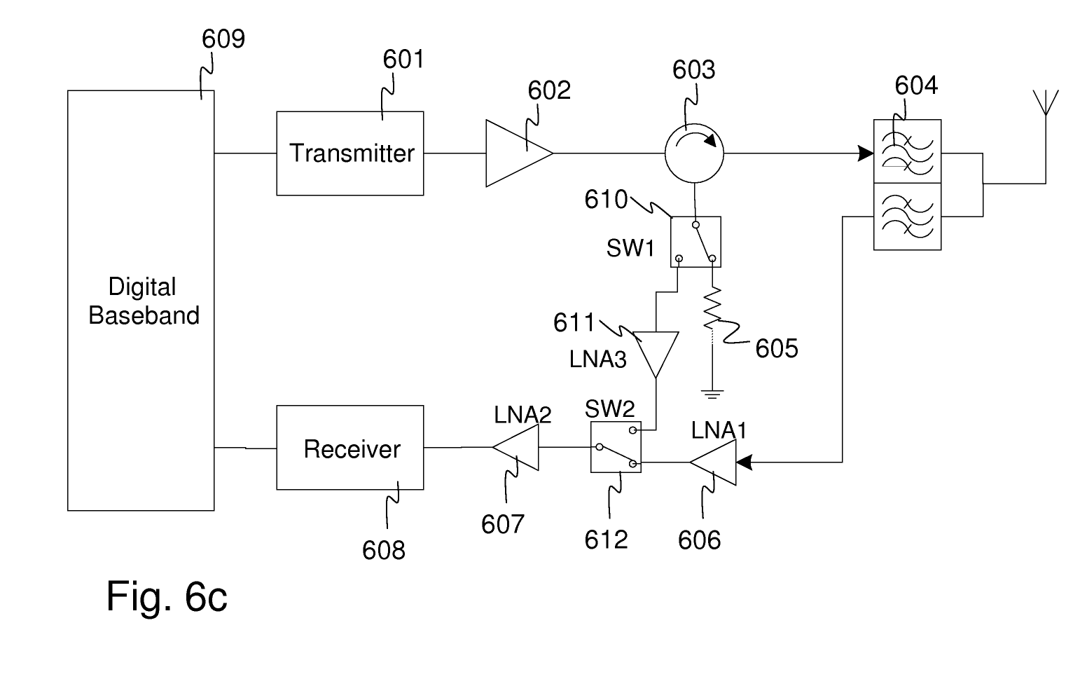

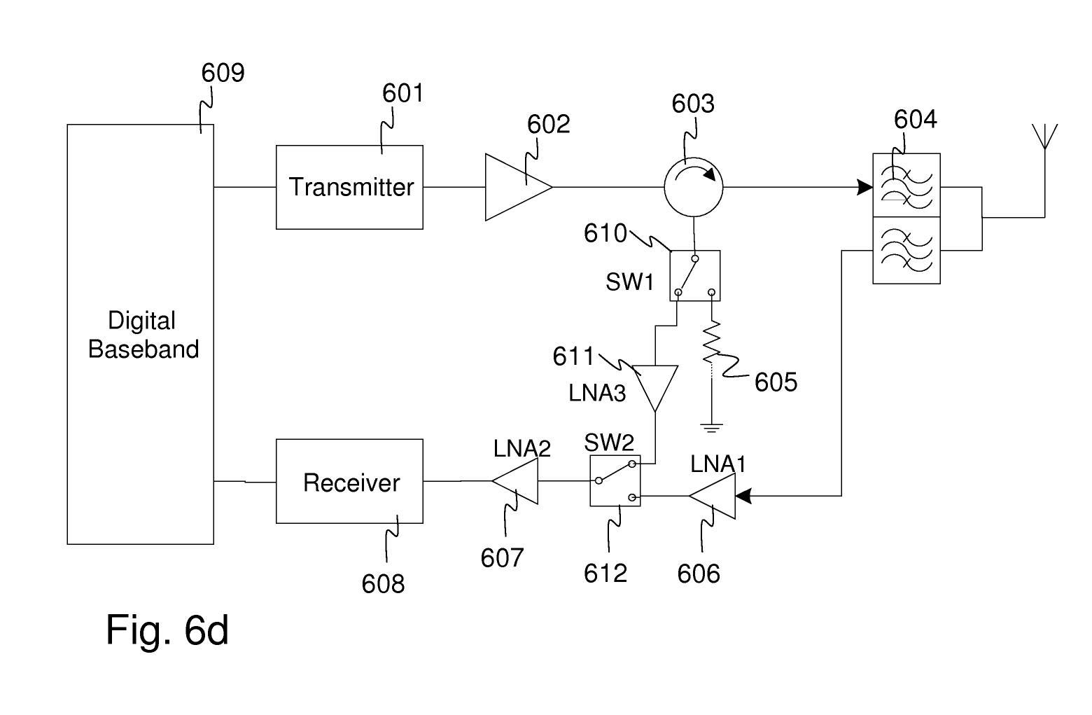

In a first embodiment, the measurements are performed by an eNodeB applying Frequency Division Duplex (FDD). An LTE FDD radio frame is illustrated in FIG. 6a. There are two carrier frequencies, one for uplink transmission (fUL) and one for downlink transmission (fDL). During each radio frame, there are thus ten uplink subframes and ten downlink subframes and uplink and downlink transmission can occur simultaneously within a cell.

FIG. 6b illustrates a block diagram of an LTE FDD eNodeB according to prior art. For downlink (DL) transmission, a transmitter 601 up-converts a DL digital signal to a low Radio Frequency (RF) signal, and outputs this RF signal to a Power Amplifier (PA) 602 to amplify the DL output power. The PA 602 is connected to a duplexer 604 through a Circulator 603. The third port of the Circulator 603 is terminated with a Load Resistor 605, which can absolve the reflected DL signal to protect the PA transistor. For Uplink (UL) reception, the received RF signal is directed to a first 606 and a second 607 Low-Noise Amplifier (LNA1 and LNA2) through the duplexer 604, and further to a receiver 608 which down-converts the UL RF to a digital signal. The Digital Baseband 609 is used for digital signal modulation and demodulation.

FIG. 6c illustrates a block diagram of the LTE FDD eNodeB updated to support neighbor eNodeB listening. A switch (SW1) 610 is added at the Circulator 603, and another switch (SW2) 612 is added between the LNA1 606 and the LNA2 607. In normal operational mode, the SW1 610 is switched to the load resistor 605, and the SW2 612 is switched to connect the LNA1 606 with the LNA2 607. The LNA3 611 is shut off or disabled. The SW2 612 is after the LNA1 606, so there is only a very minor degradation of the noise figure (NF) due to the SW2 612.

FIG. 6d illustrates a block diagram of the LTE FDD eNodeB when it is in a neighbor eNodeB listening mode. The transmitter 601, the PA 602, and the LNA1 606 are shut off or disabled. The SW1 610 is switched to the LNA3 611, and the SW2 612 is switched to connect the LNA3 611 with the LNA2 607. The LNA3 611 is added between the SW1 610 and the SW2 612 to get a good NF for the receiving channel which works for neighbor eNodeB listening. Of course, the receiver 608 also needs to be tuned to the neighbor eNodeB DL frequency for listening.

Hereinafter, the procedure for an LTE FDD eNodeB listening to the neighbor eNodeB PRS is described. When the procedure starts the eNodeB is transmitting in DL and receiving in UL, the SW1 is switched to the load resistor, and the SW2 is switched to the LNA1. When it is time for the eNodeB to listen to a neighbor eNodeB PRS, the DL and the LNA1 is shut down, and the SW1 as well as the SW2 is switched to the LNA3. The receiver's synthesizer is tuned to the neighbor eNodeBs DL frequency, and the eNodeB measures the time of arrival of the neighbor eNodeB PRS, and determines a relative time of arrival, either compared to its own PRS time of arrival or compared to some other neighbor eNodeB PRS time of arrival. When ready with the measurement, the SW1 is switched back to the load resistor, the SW2 is switched to the LAN1, and the DL and the LNA1 are turned on.

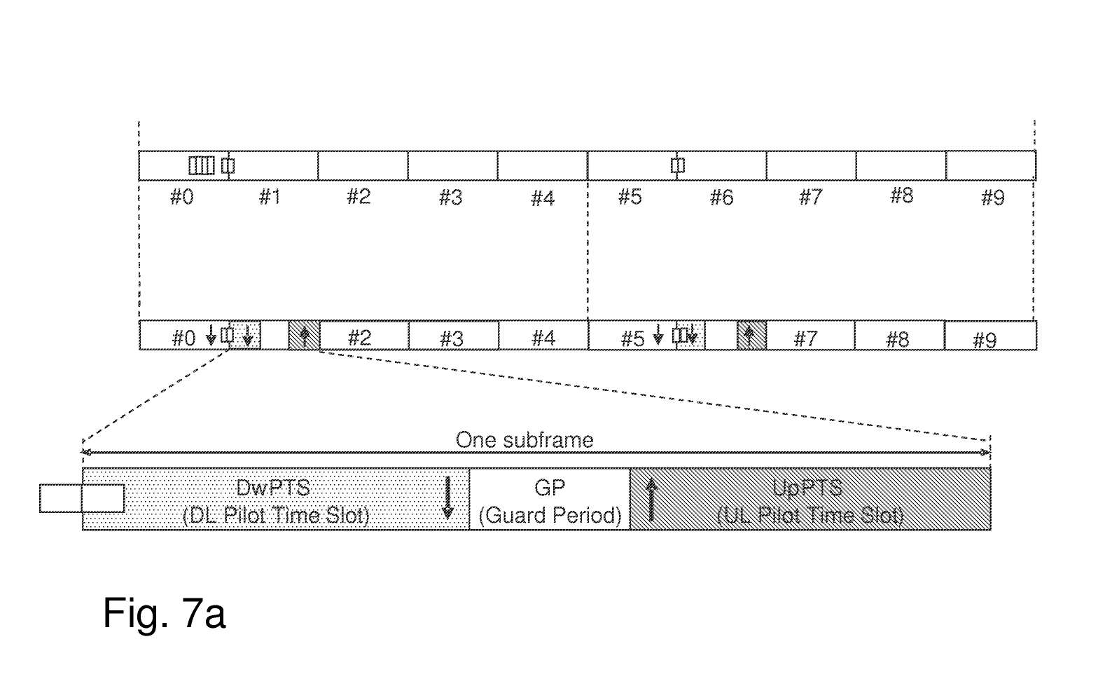

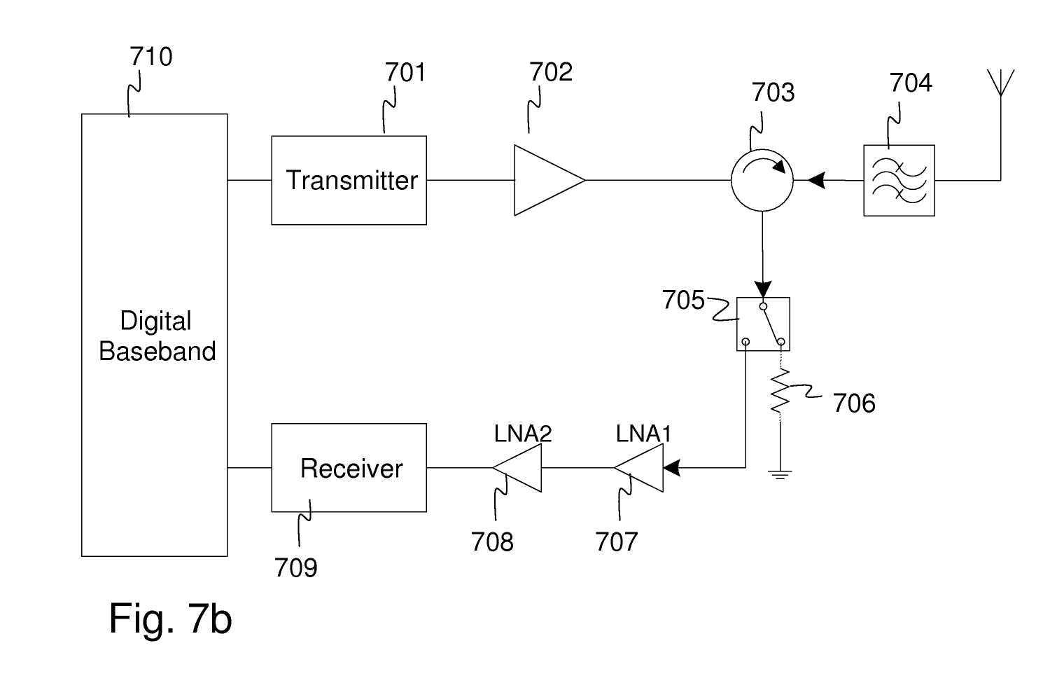

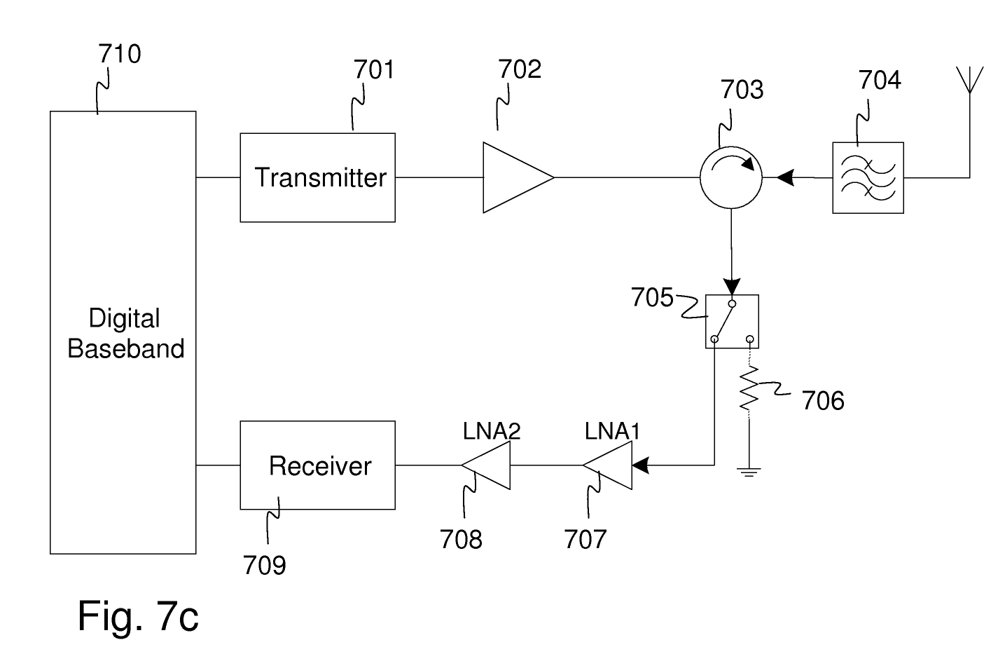

In a second embodiment, the measurements are performed by an eNodeB applying Time Division Duplex (TDD). An LTE TDD radio frame is illustrated in FIG. 7a. The high-level time-domain structure for LTE transmissions is illustrated, where each radio frame of length 10 ms consists of ten equally sized subframes of length 1 ms.

FIG. 7b illustrates a block diagram of an LTE TDD eNodeB transmitting in a DL time slot according to prior art. For DL transmissions, a transmitter 701 up-converts the DL digital signal to a low RF signal, and outputs this RF signal to a PA 702 to boost the DL output power. The PA 702 is connected to a RF filter 704 through a Circulator 703. The third port of the Circulator 703 is terminated with a Load Resistor 706 through a TDD switch 705. The TDD switch 705 is switched to the load resistor 706 at DL transmission. The LNA1 707, the LNA2 708 and the receiver 709 are all shut off or disabled during DL time slots. The Digital Baseband 710 is used for digital signal modulation.

FIG. 7c illustrates a block diagram of the LTE TDD eNodeB when receiving in an UL time slot. The transmitter 701 and the PA 702 are shut off or disabled. The TDD switch 705 is switched to the LNA1 707. The Digital Baseband 710 is used for digital signal demodulation.

When the LTE TDD eNodeB changes to neighbor eNodeBs listening mode, it actually uses the same block diagram as in FIG. 7c, but it will receive neighbor eNodeBs radio signal during a DL time slot, instead of during an UL time slot.

Hereinafter, the procedure for an LTE TDD eNodeB listening to the neighbor eNodeB PRS is described. When the procedure starts, the eNodeB is transmitting in the DL, the UL is turned off, and the SW1 is switched to the load resistor. When it is time to listen to a neighbor eNodeB PRS, the DL is turned off, the SW1 is switched to the LNA1 and the UL is turned on. If the neighbor eNodeB's frequency is different, the receiver's synthesizer needs to be tuned to the right DL frequency before the PRS can be received and the time of arrival measured. A relative time of arrival may then be derived from the measurement. If the next time slot is to be used for UL reception, the DL is turned off, the SW1 is switched to the LNA1 and the UL is turned on, so that the eNodeB may receive in the UL.

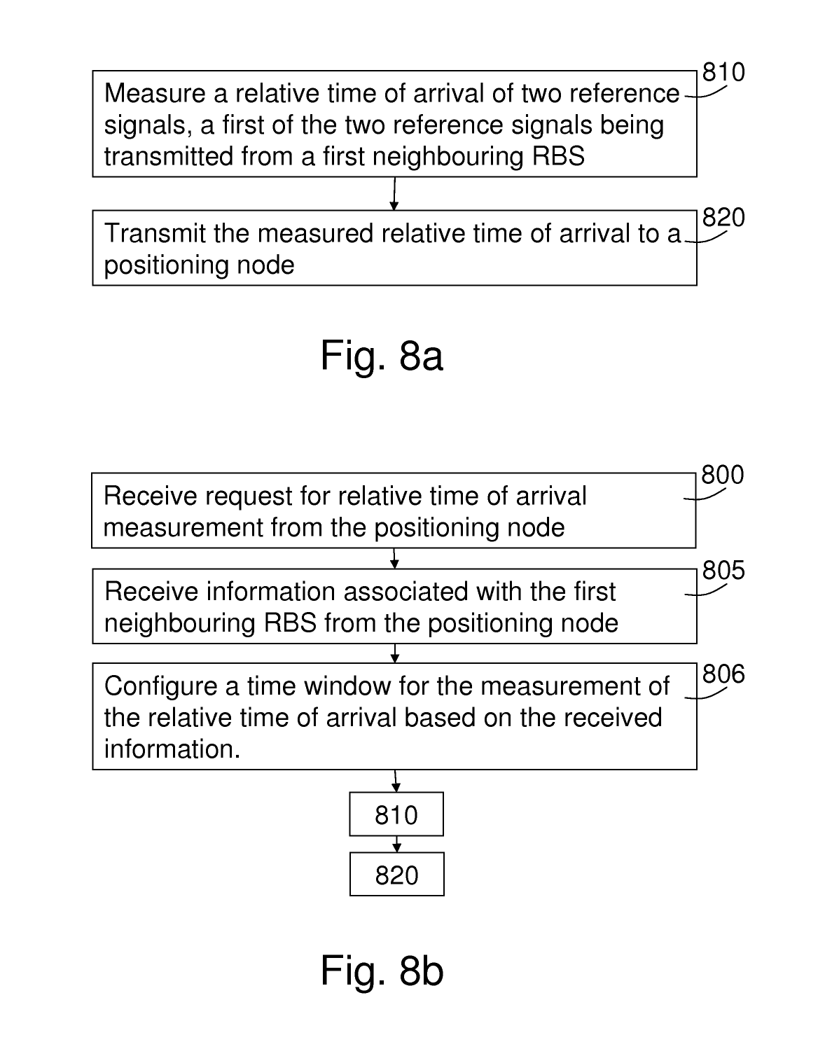

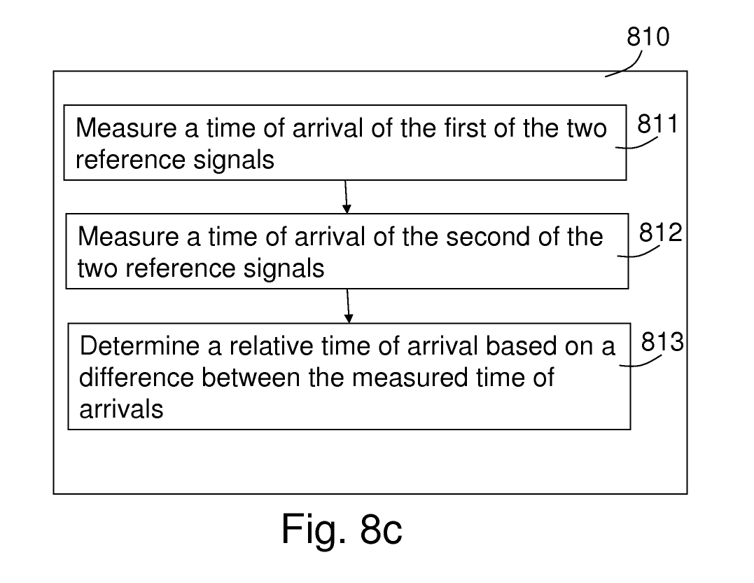

FIG. 8a is a flowchart of the method according to an embodiment, for use in a RBS of a communications system for supporting positioning. The RBS may be an eNodeB of an LTE communications system. The method comprises:
810: Measuring a relative time of arrival of two RSs, wherein a first of the two RSs is transmitted from a first neighboring RBS.
820: Transmitting the measured relative time of arrival to a positioning node connected to the RBS and the first neighboring RBS. The positioning node may be an eSMLC in an LTE communications system.

FIG. 8b is a flowchart of the method according to another embodiment. The method comprises:
800: Receiving a request for a relative time of arrival measurement from the positioning node.
805: Receiving information associated with the first neighboring RBS, the information comprising one or more of a RS configuration, an antenna location, and a timing information. The information associated with the first neighboring RBS may be received from one or more of an OSS, the first neighboring RBS, and the positioning node.
806: Configuring a time window for the measurement of the relative time of arrival based on the received information.
810: In response to the request in 800, measuring a relative time of arrival of two RSs, wherein a first of the two RSs is transmitted from a first neighboring RBS.
820: Transmitting the measured relative time of arrival to a positioning node connected to the RBS and the first neighboring RBS.

In any of the embodiments of FIG. 8a or FIG. 8b, a second of the two RSs may be from the RBS itself, or alternatively from a second neighboring RBS. The relative time of arrival of the RS of the first neighboring RBS is thus measured relative the time of arrival of either the measuring RBS's RS, or a second RBS's RS. The RSs that are measured may be PRSs, cell specific RSs, UE-specific RSs or MBSFN RSs.

In another embodiment illustrated in FIG. 8c, the measuring 810 of the relative time of arrival comprises:
811: Measuring a time of arrival of the first of the two RSs.
812: Measuring a time of arrival of the second of the two RSs.
813: Determining a relative time of arrival based on a difference between the measured time of arrivals of the first and the second of the two RSs.

This is possible as the short term stability of the RBS often is very good, so the accuracy may be as good as for measuring the relative time of arrival directly.

In another embodiment, the method in the RBS further comprises calculating an uncertainty of the measured relative time of arrival, and transmitting the calculated uncertainty to the positioning node. It may e.g. be transmitted in the same message as the measured relative timing.

In still another embodiment, the bsAlign indicator is derived from the relative timing measurement. The method then further comprises determining a relative offset based on the measured relative time of arrival, and comparing the determined relative offset with a threshold value. When the determined relative offset is below the threshold value the bsAlign indicator associated with the first neighboring RBS is set to true. Otherwise the indicator is set to false. The bsAlign indicator is transmitted to the positioning node. In an alternative embodiment, the determining of relative offsets and the setting of the bsAlign indicator are done in the positioning node and not in the RBS.

As described above with reference to FIGS. 6a-d and 7a-c, a downlink transmission resource may be used for measuring the relative time of arrival.

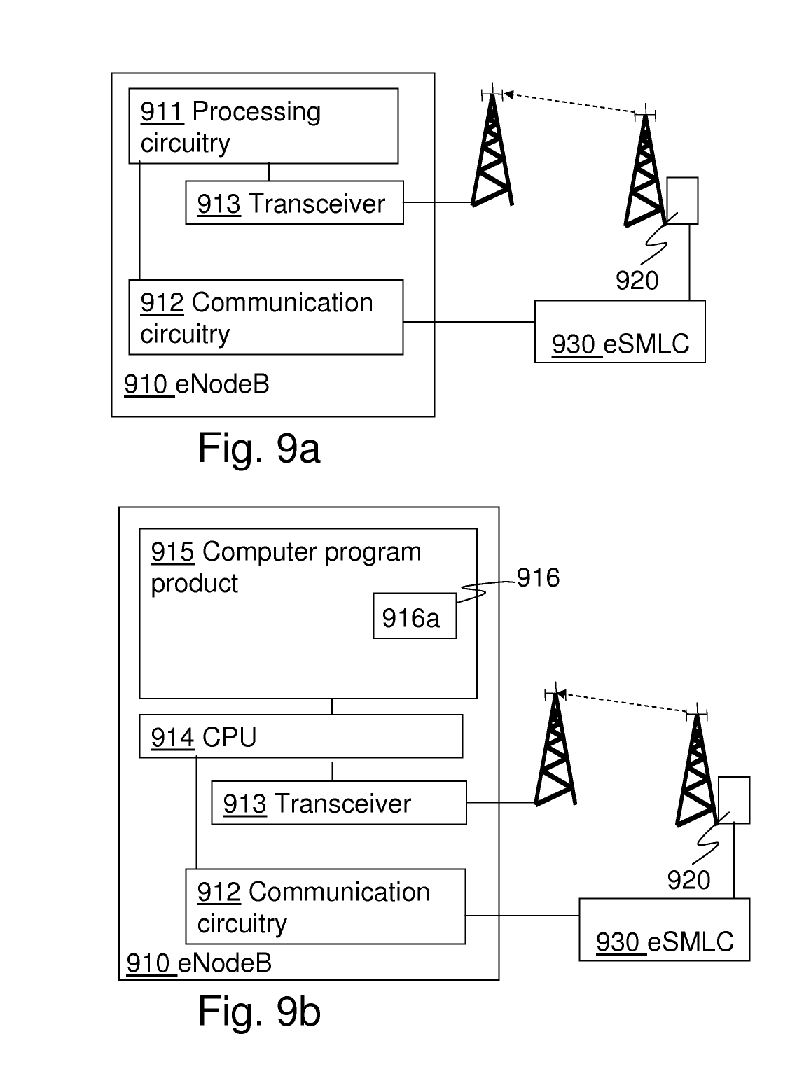

An RBS 910 of a communications system, a neighboring RBS 920, and a positioning node 930 are schematically illustrated in FIGS. 9a and 9b, according to embodiments of the invention. The RBS, configured to support positioning, comprises a processing circuitry 911 adapted to measure a relative time of arrival of two RSs, wherein a first of the two RSs is transmitted from a first neighboring RBS 920. The RBS also comprises a communication circuitry 912 adapted to transmit the measured relative time of arrival to the positioning node 930 connectable to the RBS 910 and to the first neighboring RBS 920. Furthermore, the RBS comprises a transceiver 913 for the radio communication with UEs and for the listening to neighbor RBSs as described above with reference to FIGS. 6a-d and 7a-c.

In another embodiment, the communication circuitry 912 is further adapted to receive information associated with the first neighboring RBS 920, the information comprising at least one of a RS configuration, an antenna location, and a timing information. The processing circuitry 911 is further adapted to configure a time window for the measurement of the relative time of arrival based on the received information. The information associated with the first neighboring RBS 920 may be received from at least one of an OSS, the first neighboring RBS 920, or the positioning node 930.

In embodiments, the communication circuitry 912 is further adapted to receive a request for a relative time of arrival measurement from the positioning node, and the processing circuitry 911 is further adapted to measure the relative time of arrival in response to the received request.

Furthermore, the processing circuitry 911 may be further adapted to measure the relative time of arrival by measuring a time of arrival of the first of the two RSs, measuring a time of arrival of the second of the two RSs, and determining a relative time of arrival based on a difference between the measured time of arrivals of the first and the second of the two RSs.

The processing circuitry 911 may also be further adapted to calculate an uncertainty of the measured relative time of arrival, and the communication circuitry 912 may be further configured to transmit the calculated uncertainty to the positioning node.

The processing circuitry 911 is in embodiments further adapted to determine a relative offset based on the measured relative time of arrival, to compare the determined relative offset with a threshold value, and to set a base station align indicator associated with the first neighboring RBS to true when the determined relative offset is below the threshold value, and to false otherwise, and the communication circuitry 912 may be further adapted to transmit the base station align indicator to the positioning node.

The processing circuitry 911 may be further adapted to measure the relative time of arrival using a downlink transmission resource.

The circuitry described above with reference to FIG. 9a may be logical circuits, separate physical circuits, or a mixture of both.

FIG. 9b schematically illustrates an embodiment of the RBS 910, which is an alternative way of disclosing the embodiment illustrated in FIG. 9a. The RBS 910 comprises the transceiver 913 and the communication circuitry 912 already described above, as well as a Central Processing Unit (CPU) 914 which may be a single unit or a plurality of units. Furthermore, the RBS 910 comprises at least one computer program product 915 in the form of a non-volatile memory, e.g. an EEPROM (Electrically Erasable Programmable Read-Only Memory), a flash memory or a disk drive. The computer program product 915 comprises a computer program 916, which comprises code means which when run on the RBS 910 causes the CPU 914 on the RBS 910 to perform the steps of the procedures described earlier in conjunction with FIG. 8a.

Hence in the embodiments described, the code means in the computer program 916 of the RBS 910 comprises a measuring module 916a for measuring a relative time of arrival. The code means may thus be implemented as computer program code structured in computer program modules. The module 916a essentially performs the step 810 of the flow in FIG. 8a to emulate the RBS described in FIG. 9a. In other words, when the module 916a is run on the CPU 914, it corresponds to the unit 911 of FIG. 9a.

Although the code means in the embodiment disclosed above in conjunction with FIG. 9b are implemented as computer program modules which when run on the RBS 910 causes the node to perform the step described above in conjunction with FIG. 8a, one or more of the code means may in alternative embodiments be implemented at least partly as hardware circuits.

The above mentioned and described embodiments are only given as examples and should not be limiting to the present invention. Other solutions, uses, objectives, and functions within the scope of the invention as claimed in the accompanying patent claims may also be possible.

### ABBREVIATIONS

3GPP 3rd Generation Partnership Program

A-GPS Assisted GPS

ASN.1 Abstract Syntax Notation One

CID Cell Identity based positioning

DL Downlink

E-CID Enhanced CID

eNodeB Evolved Node B

eSMLC Evolved Serving Mobile Location Center

E-UTRAN Evolved UTRAN

FCC Federal Communications Commission

FDD Frequency Division Duplex

GNSS Global Navigation Satellite System

GPS Global Positioning System

LNA Low Noise Amplifier

LPP LTE Positioning Protocol

LPPa LPP annex

LTE Long Term Evolution

MBSFN Multimedia Broadcast multicast service Single Frequency Network

MME Mobility Management Entity

NF Noise Figure

OCXO Oven-Controlled Crystal Oscillator

OSS Operations Support System

OTDOA Observed TDOA

PA Power Amplifier

PRS Positioning RS

RAN Radio Access Network

RBS Radio Base Station

RF Radio Frequency

RS Reference Signal

RTD Relative Time Difference

SFN System Frame Number

SW Switch

TDD Time Division Duplex

TDOA Time Difference Of Arrival

UE User Equipment

UL Uplink

UMTS Universal Mobile Telecommunications System

UTDOA Uplink TDOA

UTRAN Universal Terrestrial RAN

1. A method for use in a radio base station of a communications system, for supporting positioning, the method comprising:
measuring a relative time of arrival of two reference signals, wherein a first of the two reference signals is transmitted from a first neighboring radio base station, and
transmitting the measured relative time of arrival to a positioning node, connected to the radio base station and the first neighboring radio base station.

2. The method according to claim 1, further comprising:
receiving information associated with the first neighboring radio base station, the information comprising at least one of a reference signal configuration, an antenna location, and a timing information, and
configuring a time window for the measurement of the relative time of arrival based on the received information.

3. The method according to claim 2, wherein the information associated with the first neighboring radio base station is received from at least one of an operations support system, the first neighboring radio base station, or the positioning node.

4. The method according to claim 1, wherein a second of the two reference signals is transmitted from the radio base station.

5. The method according to claim 1, wherein a second of the two reference signals is transmitted from a second neighboring radio base station.

6. The method according to claim 1, further comprising:
receiving a request for a relative time of arrival measurement from the positioning node,
wherein the relative time of arrival is measured in response to the received request.

7. The method according to claim 1, wherein measuring the relative time of arrival comprises:
measuring a time of arrival of the first of the two reference signals,
measuring a time of arrival of the second of the two reference signals, and
determining a relative time of arrival based on a difference between the measured time of arrivals of the first and the second of the two reference signals.

8. The method according to claim 1, further comprising:
calculating an uncertainty of the measured relative time of arrival, and
transmitting the calculated uncertainty to the positioning node.

9. The method according to claim 1, further comprising:
determining a relative offset based on the measured relative time of arrival,
comparing the determined relative offset with a threshold value,
setting a base station align indicator associated with the first neighboring radio base station to true when the determined relative offset is below the threshold value, and setting the base station align indicator associated with the first neighboring radio base station to false when the determined relative offset is above the threshold value, and
transmitting the base station align indicator to the positioning node.

10. The method according to claim 1, wherein the two reference signals are two positioning reference signals.

11. The method according to claim 1, wherein a downlink transmission resource is used for measuring the relative time of arrival.

12. A radio base station of a communications system, configured to support positioning, the radio base station comprising:
a processing circuitry adapted to measure a relative time of arrival of two reference signals, wherein a first of the two reference signals is transmitted from a first neighboring radio base station, and
a communication circuitry adapted to transmit the measured relative time of arrival to a positioning node connectable to the radio base station and the first neighboring radio base station.

13. The radio base station according to claim 12, wherein the communication circuitry is further adapted to receive information associated with the first neighboring radio base station, the information comprising at least one of a reference signal configuration, an antenna location, and a timing information, and the processing circuitry is further adapted to configure a time window for the measurement of the relative time of arrival based on the received information.

14. The radio base station according to claim 13, wherein the information associated with the first neighboring radio base station is received from at least one of an operations support system, the first neighboring radio base station, or the positioning node.

15. The radio base station according to claim 12, wherein a second of the two reference signals is transmitted from the radio base station.

16. The radio base station according to claim 12, wherein a second of the two reference signals is transmitted from a second neighboring radio base station.

17. The radio base station according to claim 12, wherein the communication circuitry is further adapted to receive a request for a relative time of arrival measurement from the positioning node, and the processing circuitry is further adapted to measure the relative time of arrival in response to the received request.

18. The radio base station according to claim 12, wherein processing circuitry is further adapted to measure the relative time of arrival by:
measuring a time of arrival of the first of the two reference signals,
measuring a time of arrival of the second of the two reference signals, and
determining a relative time of arrival based on a difference between the measured time of arrivals of the first and the second of the two reference signals.

19. The radio base station according to claim 12, wherein the processing circuitry is further adapted to calculate an uncertainty of the measured relative time of arrival, and the communication circuitry is further configured to transmit the calculated uncertainty to the positioning node.

20. The radio base station according to claim 12, wherein the processing circuitry is further adapted to determine a relative offset based on the measured relative time of arrival, to compare the determined relative offset with a threshold value, and to set a base station align indicator associated with the first neighboring radio base station to true when the determined relative offset is below the threshold value, and to set the base station align indicator associated with the first neighboring radio base station to false when the determined relative offset is above the threshold value, and wherein the communication circuitry is further adapted to transmit the base station align indicator to the positioning node.

21. (canceled)

22. (canceled)
